(19) United States
(12) Patent Application Publication
(10) Pub. No.: US 2014/0112091 A1
(43) Pub. Date: Apr. 24, 2014

(54) PROCESS FOR PREPARING MOLD-SAND AND A DEVICE FOR PUTTING THE SAME INTO PRACTICE

(71) Applicant: ZAKRYTOE AKTSIONERNOE OBSCHESTVO "LITAFORM", Moscow (RU)

(72) Inventors: Anatoly Alexandrovich VOLKOMICH, Moscow (RU); Rudolf Rudolfovich LUTTS, Moscow (RU); Nikolay Ivanovich BEKH, Moscow (RU); Alexandr Mihailovich GOROHOVSKY, Moscow (RU); Gennady Ivanovich DEGTYARENKO, Moscow (RU)

(73) Assignee: ZAKRYTOE AKTSIONERNOE OBSCHESTVO "LITAFORM", Moscow (RU)

(21) Appl. No.: 14/087,105

(22) Filed: Nov. 22, 2013

Related U.S. Application Data
(63) Continuation of application No. PCT/RU2011/000861, filed on Nov. 7, 2011.

(30) Foreign Application Priority Data
May 24, 2011 (RU) 2011120720

(51) Int. Cl. B01F 15/00

(52) U.S. Cl. CPC B01F 15/0024
USPC 366/140

(57) ABSTRACT

A process for preparing mold-sand includes the steps of pouring a proportioned amount of mold-sand components into a mixer, adding the calculated amount of water, mixing the components, taking a sample and measuring the mold-sand moisture content. After taking a representative sample from the mixer, this sample is used to make a specimen by its compaction, and the moisture content is measured with the consequent adjustment of the moisture content in the considered mix batch, and the sampling is carried out by repeated pushing the mixture down into a case with the help of a periodically-operated butterfly valve until its filling with the mixture, and then the mold-sand mixture is compacted in the case with a plunger. A device prepares the mold-sand.

### FIELD OF THE INVENTION

The present invention relates to the field of foundry and namely to the technology of preparing mold-sands and controlling their properties, in particular the moisture content during the mold-sand preparation.

### BACKGROUND OF THE INVENTION

A process for preparing mold-sand, comprising the steps of proportioning heap and virgin sands, bentonite and water, filling with the sand components a rotating mixing drum where the sand is homogenized and where it can be simultaneously cooled under vacuum, as well as its moisture level is measured enabling to accurately calculate a necessary amount of water to add to a particular sand mixture (see the revue <<CASTING Plant and Technology>>, 2009, pp. 5,6). Moisture is measured according to said process with a probe plunged into the mold-sand and having a moisture detector fixed on its end (see the advertising brochure of the Company EIRICH, “Equipment for preparing mold-sands”, page 9, 07.2006, Germany).

A drawback of the known process consists in a limitation due to the possibility to use it only in the cases when the probe is plunged into an approach stream of mold-sand, which provides for formation of a rather stable compacted sand area with a permanent structure in front of the moisture detector. In the previous described process using probes, such a mold-sand stream is formed as a result of the mixer bowl rotation. But said process of moisture checking can not be used in mixers with a fixed bowl, since plunging the probe into a non-compacted mold-sand with an incoherent structure will not provide the main condition for a stable operation of the moisture detector, a tight contact of its surface with the sand mixture. Respectively, the detector readings will not be stable in this case.

A process for determining the properties of molding materials is known, where in the stage of preparing mold-sand by admixture of starting molding materials, a molding material sample is taken, it is brought to a constant volume, then it is compacted with a piston and the water content is determined by a detector operating on the basis of a dielectric constant with the use of the molding material temperature measured by a temperature probe; and a device for realizing said process is known, which comprises a sampler actuated by a lift cylinder, a sample being lifted to a pushing out cylinder, then the sample fills, via a funnel, a cylindrical test case located on a base, and after eliminating with a scraper the mold-sand in excess, the test case passes to a compacting post where the sample is compacted by a punch with a compacting hydraulic cylinder and further is transferred to a test and ultrasound measurement post (see RU patent No2140074, Int. Cl. G01 N 29/00, published on 20 Oct. 1999).

Nevertheless, the use of said known process and device is limited, since the described testing operations are conducted outside the device for mold-sand preparing, which does not enable the use of the results for modifying the composition and, consequently, the properties of the current mix batch. Furthermore, the device for realizing said process is unwieldy and technologically complicated.

As to the technical essence, the closest to the technical solutions of the present invention are a process for preparing mold-sand, comprising the steps of: pouring mold-sand components into a mixer, adding a metered admixture of water, mixing the components, continuous sampling from the upper layer of the mold-sand under agitation and determining its moisture, the mixing being stopped when the upper mold-sand layer reaches the maximal moisture level, as well as, respectively, a device for realizing the same, comprising equipment to conduct the moisture checking made as a sampler providing simultaneously moisture measuring and fixed at the upper mold-sand level (see USSR Author's Certificate No 958035, Int. Cl. B22 C5/04, published on 15 Sep. 1982).

However said previous technical solutions are not foreseen for a mold-sand moisture control that could provide for its value regulation either, but they only evaluate the mold-sand moisture content variation during the process of its preparation as a result of a uniform water distribution around the mold-sand volume. When this relation reaches a maximal value when the moisture of the prepared mold-sand is close to the prescribed value, the mill is discharged.

Thus, while putting said known process into practice, only the moment of reaching an optimal time of mold-sand mixing for a given amount of water added is registered.

But the evaluation of this parameter with the use of said known process and device for continuous checking the relative moisture of the mold-sand mixture is not precise either, since the heterogeneity of the structure and the mass of the taken sample does not guarantee the exactitude of the results of checking, which is very important when the technology uses a combination of processes for the mold-sand preparing and cooling.

The closest solution to the present invention is a process of mold-sand preparing, comprising the steps of pouring proportioned amounts of the mold-sand components into a mixer, adding a calculated amount of water, mixing the components, taking a sample, preparing a specimen directly in the mixer, after taking the sample, compacting the last in a moisture modifier with the help of a running roller, measuring the mold-sand moisture and its regulating until reaching a prescribed value (SU 250373 A1, published on 12 Aug. 1969). A device for realizing the process comprises a mixer under the form of a fixed pan containing mixing elements and an assembly to control moisture fixed on a pan wall and made under the form of a moisture converter having an interelectrode space where the mold-sand is compacted by a running roller of a mixing mill.

The drawbacks of the previous process and device are:
instability of filling the converter with mold-sand by the mixing mill roller due to a short time of the process, that is not more than ⅓ second;
Instability of the mold-sand compaction by the roller, since the compaction grade depends on the level of filling the converter with mold-sand; as a result, a situation can arise when the mold-sand in the converter is not compacted at all, the results of the measurement will not correspond to the real moisture of the mixture.

### SUMMARY OF THE INVENTION

The essence of the present invention task is to develop a process for preparing mold-sand and a device to realize the same, providing for a stable process of taking a sample and compacting it, as well as for a higher precision of the moisture control, which will enable a higher efficiency of the whole process for the manufacture of castings.

The task assigned is solved thanks to the fact that in a process for preparing a mold-sand mixture, a proportioned amount of the mixture components is poured into a mixer, a calculated amount of water is added, the components are mixed, a sample is taken, a specimen is made directly in the mixer from said sample by its compaction, and the measurement of the mold-sand mixture moisture, with the following moisture adjustment in the current mold-sand mix batch, the sampling being carried out by a repeated pushing the mixture down into a case with the help of a periodically-operated butterfly valve until its filling with the mixture, and then the mold-sand mixture is compacted in the case with a plunger, besides, in the device for preparing the mold-sand mixture, comprising a mixer under the form of a fixed pan containing mixing elements under the form of shares and of vortex heads, and an assembly for controlling the mold-sand moisture fixed on a wall of said pan above the level of the shares, according to the present invention, the assembly for controlling the mold-sand mix moisture comprises a case for forming a specimen and fixed obliquely on the wall of the fixed pan, at one end of which a plunger with a built-in moisture probe and an air cylinder are mounted, its other open end located inside the mixer being provided with an additional air cylinder and a periodically-operated butterfly valve serving to fill the case with mold-sand, and in another embodiment of the device according to the invention, to provide cooling of the mold-sand during the process of mold-sand preparation, the pan bottom presents an air-supply channel, and the shares present a longitudinal cavity with holes in their rear wall.

The object of the inventions is to provide the mold-sand mix moisture checking during the process of mold-sand preparing and to adjust the moisture of the mix batch under control in order to stabilize moisture and, respectively, the mold-sand compaction. This will enable to increase the efficiency of the whole process for the manufacture of castings.

### BRIEF DESCRIPTION OF THE DRAWINGS

The embodiments of putting the inventions into practice are illustrated by the following drawings:

FIG. 1 illustrates a device for preparing a mold-sand mixture;

FIG. 2 illustrates an assembly for controlling the mold-sand mix moisture;

FIG. 3 illustrates an embodiment of a device for preparing a mold-sand mixture.

### PREFERRED EMBODIMENT TO PUT THE INVENTION INTO PRACTICE

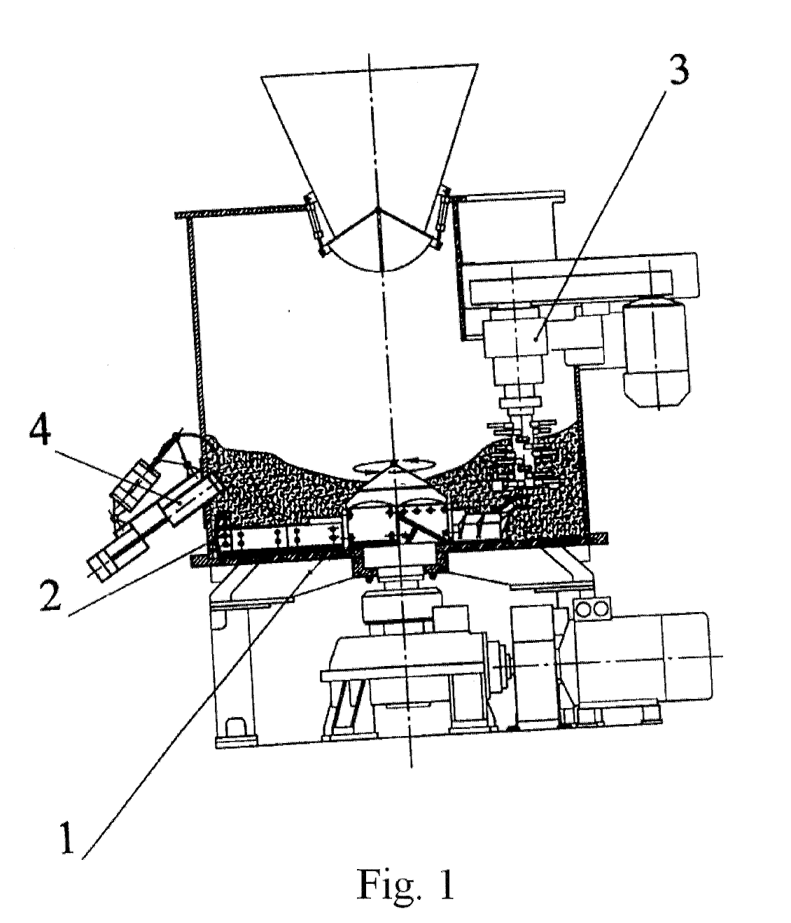

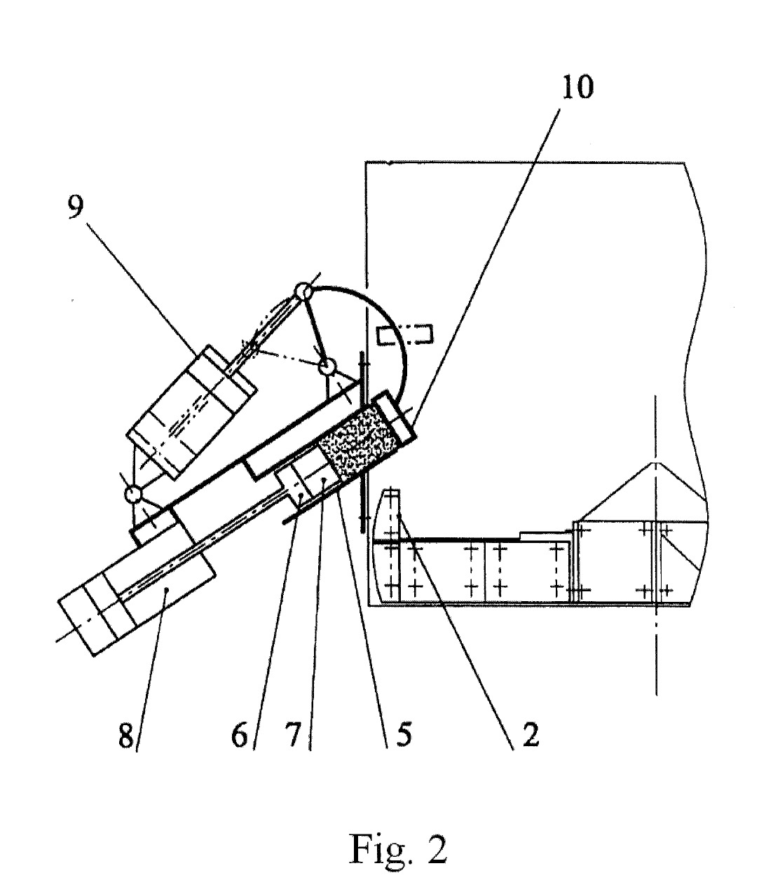

FIG. 1 illustrates a device for preparing a mold-sand mixture, and FIG. 2 illustrates an assembly for controlling its moisture.

The device for preparing a mold-sand mixture comprises a mixer under the form of a fixed pan 1 containing mixing elements under the form of shares 2 and a vortex head 3, as well as an assembly (probe) 4 for checking the mold-send mix moisture, comprising a case 5, a plunger 6 with a moisture detector 7. The assembly (probe) 4 for mold-sans moisture checking is fixed on a wall of the pan 1 above the level of the shares 2 and contains a case 5 to form a specimen, fixed obliquely on the wall of the fixed pan 1. At one end of the case 5, a plunger 6 with a built-in moisture probe 7 and an air cylinder 8 are mounted, and the other open end of the case 5 located inside the pan 1 is provided with an additional air cylinder 9 and with a periodically-operated butterfly valve 10 serving to fill the case 5 with mold-sand.

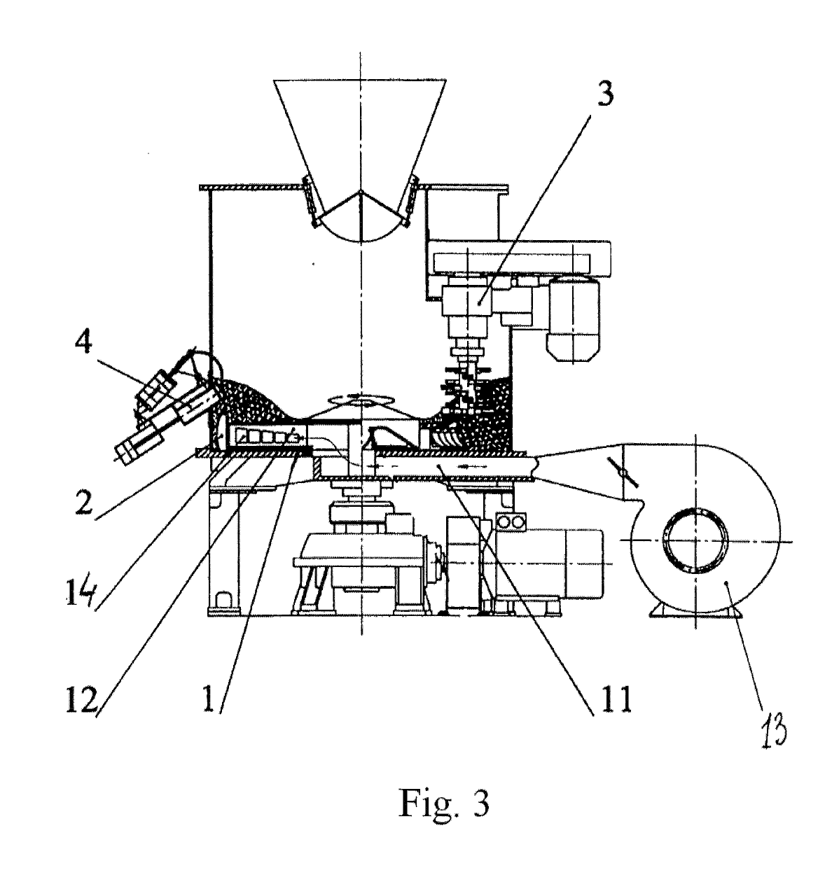

Furthermore, the device of the second embodiment (see FIG. 3) to provide cooling of the mold-sand mixture during the process of mold-sand preparing comprises an air supply channel 11 open in the bottom of the pan 1, and the shares 2 present a longitudinal cavity 12 to enable air passage from a fan 13 and holes 14 in the rear wall of the shares 2.

The process of preparing mold-sand is carried out as follows.

The process for preparing mold-sand comprises the steps of: filling a proportioned amount of mold-sand components into a mixer, adding a calculated amount of water, mixing the components, taking a sample and measuring the mold-sand moisture. A particularity of the process is that after taking a representative sample, a specimen is manufactured with this sample in the mixer by its compaction, and further its moisture is measured to be followed by the moisture adjustment in the considered mix batch.

In the operation of the devices, a proportioned amount of the mold-sand components is put into a fixed pan 1, a calculated amount of water is added to prepare (or to prepare and to cool) the mold-sand, the mold-sand is mixed with the rotating shares 2 and with the vortex head 3 that convert the mixture to suspension, and, in case of combining the steps of mold-sand preparing and cooling, the mixture is blown through with a directed stream of air supplied from the fan 13 via the air supply channel 11 and the holes 14 in the shares 2. During the process of preparing the mold-sand mixture, after reaching a relatively homogenous composition of the mixture, 30 to 40 seconds after loading all the initial materials into the mixer, the air cylinder 9 moves the butterfly valve 10 to an end position and opens the neck of the case 5 to enable free pouring, into it, of the mold-sand moving along the fixed pan 1 of the mixer. After a short pause, the butterfly valve 10 rotates and pushes the mixture passing between the valve and the case 5 into the last. This operation is repeated until the complete filling of the case 5 with the mixture, which is noted by the valve 10 end position detector (not illustrated on the drawings). After that, the air cylinder 9 designed for moving the valve 10 operates a working stroke and performs the compaction of the mold-sand mixture in the case 5, the moisture detector determining the moisture of the compacted mold-sand mixture.

The operation according to the second embodiment of the device is similar to the above described, in this case, in order to provide cooling of the mold-sand mixture during its preparation, additional air passes from the fan 13 via the air supply channel 11, the longitudinal channel 12 and the holes 14 in the shares to the mold-sand mixture to cool it.

A comparison of the technical solutions according to the present invention with the closest state of the art enables us to state they satisfy the criterion of “novelty”, and the absence of our new features in the previous art solutions means they satisfy the criterion of “inventive level”.

### INDUSTRIAL APPLICABILITY

The above described advantages of the technical solutions according to the present invention provide for a possibility of a wide industrial use in the field of foundry and enable to improve the efficiency of the mold-sand preparation and to adjust the moisture content while preparing a mix batch with the moisture control.

1. A process for preparing mold-sand comprising the steps of: pouring a proportioned amount of mold-sand components into a mixer, adding a calculated amount of water, mixing the components, taking a sample, making a specimen directly in the mixer with said sample by its compaction, and measuring the mold-sand mixture moisture, with the following moisture adjustment in the current mold-sand mix batch, wherein the sampling is carried out by repeated pushing the mixture down into a case with the help of a periodically-operated butterfly valve until its filling with the mixture, and then the mold-sand mixture is compacted in the case with a plunger.

2. The device for preparing mold-sand, comprising a mixer under the form of a fixed pan containing mixing elements under the form of shares and of vortex heads, and an assembly for controlling the mold-sand mix moisture fixed on a wall of said pan above the level of the shares, wherein the assembly for controlling the mold-sand mix moisture comprises a case for forming a specimen and fixed obliquely on the wall of the fixed pan, at one end of which a plunger with a built-in moisture probe and an air cylinder are mounted, and its other open end located inside the mixer being provided with a periodically-operated butterfly valve serving to fill the case with mold-sand, with an additional air cylinder.

3. The device of claim 2 wherein, to provide cooling of the mold-sand during the process of mold-sand preparation, the pan bottom presents an air-supply channel, and the shares present a longitudinal cavity with holes in their rear wall.
